(19) United States
(12) Patent Application Publication
(10) Pub. No.: US 2016/0168513 A1
(43) Pub. Date: Jun. 16, 2016

(54) LIQUID CLEANING COMPOSITION

(71) Applicant: The Procter & Gamble Company, Cincinnati, OH (US)

(72) Inventors: Hans WENDT, Beijing (CN); Ruixue LI, Beijing (CN)

(21) Appl. No.: 14/944,313

(22) Filed: Nov. 18, 2015

(30) Foreign Application Priority Data
Dec. 12, 2014 (WO) CN2014/093668

(51) Int. Cl. C11D 3/00; C11D 3/37; C11D 17/00; C11D 3/50

(52) U.S. Cl. CPC C11D 3/0036; C11D 3/505; C11D 3/3723; C11D 17/0013

(57) ABSTRACT

A liquid cleaning composition comprising a soil dispersant and a microcapsule that comprises a cationically charged coating. The composition provides improved delivery efficiency of microcapsules. Also, the use of such a liquid cleaning composition for pretreating a fabric is disclosed.

### FIELD OF THE INVENTION

The present invention relates to a liquid cleaning composition. The present invention also relates to the use of a liquid cleaning composition for pretreating a fabric.

### SUMMARY OF THE INVENTION

In one aspect, the present invention is directed to a liquid cleaning composition, comprising:

a) from 0.5% to 5%, by weight of the composition, of a soil dispersant comprising an alkylene amine backbone and a side chain bonded to the nitrogen atom of the alkylene amine backbone, wherein the side chain is of formula (I),

-(EO)_{b}(PO)_{c} (I)

wherein b ranges from 3 to 60, and c ranges from 0 to 60; and

b) from 0.11% to 0.25%, by weight of the composition, of a microcapsule, wherein the microcapsule comprises: a shell comprising an outer surface, a core encapsulated within the shell, and a coating coating the outer surface, wherein the coating is cationically charged.

In another aspect, the present invention is directed to the use of the aforementioned liquid cleaning composition for pretreating a fabric.

In yet another aspect, the present invention is directed to the use of a liquid cleaning composition for pretreating a fabric, wherein the composition comprises:

a) a soil dispersant comprising an alkylene amine backbone and a side chain bonded to the nitrogen atom of the alkylene amine backbone, wherein the side chain is of formula (I),

-(EO)_{b}(PO)_{c} (I)

wherein b ranges from 3 to 60, and c ranges from 0 to 60; and

b) a microcapsule, wherein the microcapsule comprises: a shell comprising an outer surface, a core encapsulated within the shell, and a coating coating the outer surface, wherein the coating is cationically charged.

The liquid cleaning composition of the present invention provides improved delivery efficiency of microcapsules, amongst other benefits.

### DETAILED DESCRIPTION OF THE INVENTION

### Definitions

As used herein, the term “liquid cleaning composition” means a liquid composition relating to cleaning or treating: fabrics, hard or soft surfaces, skin, hair, or any other surfaces in the area of fabric care, home care, skin care, and hair care. Examples of the cleaning compositions include, but are not limited to: laundry detergent, laundry detergent additive, fabric softener, carpet cleaner, floor cleaner, bathroom cleaner, toilet cleaner, sink cleaner, dishwashing detergent, air care, car care, skin moisturizer, skin cleanser, skin treatment emulsion, shaving cream, hair shampoo, hair conditioner, and the like. Preferably, the liquid cleaning composition is a liquid laundry detergent composition, a liquid fabric softener composition, a liquid dishwashing detergent composition, or a hair shampoo, more preferably is a liquid laundry detergent composition. The term “liquid cleaning composition” herein refers to compositions that are in a form selected from the group consisting of pourable liquid, gel, cream, and combinations thereof. The liquid cleaning composition may be either aqueous or non-aqueous, and may be anisotropic, isotropic, or combinations thereof.

As used herein, the term “alkyl” means a hydrocarbyl moiety which is branched or unbranched, substituted or unsubstituted. Included in the term “alkyl” is the alkyl portion of acyl groups.

As used herein, the term “pretreat” refers to a type of user's cleaning activity that treats a fabric, particularly a portion of fabric that has tough stains, with a cleaning composition beforehand (i.e., prior to a wash cycle). Typically a tough stain is easier to be removed by pretreating because the concentration of the composition is relatively high (than that in a washing solution) and the stain is precisely targeted.

As used herein, when a composition is “substantially free” of a specific ingredient, it is meant that the composition comprises less than a trace amount, alternatively less than 0.1%, alternatively less than 0.01%, alternatively less than 0.001%, by weight of the composition of the specific ingredient.

As used herein, the articles including “a” and “an” when used in a claim, are understood to mean one or more of what is claimed or described.

As used herein, the terms “comprise”, “comprises”, “comprising”, “include”, “includes”, “including”, “contain”, “contains”, and “containing” are meant to be non-limiting, i.e., other steps and other ingredients which do not affect the end of result can be added. The above terms encompass the terms “consisting of” and “consisting essentially of”.

### Liquid Cleaning Composition

The liquid cleaning composition of the present invention comprises a soil dispersant comprising an ethylene imine and a particular repeating unit, and a microcapsule comprising a shell comprising an outer surface, a core encapsulated within the shell, and a coating coating the outer surface, wherein the coating is cationically charged. In one embodiment, the soil dispersant is present from 0.5% to 5%, preferably from 0.6% to 4%, more preferably from 0.8% to 3%, by weight of the composition, in the composition. In one embodiment, the microcapsule is present from 0.11% to 0.25%, preferably from 0.15% to 0.2%, by weight of the composition, in the composition. In the present invention, it has been found that, since the cationically charged coating enhances the deposition of the microcapsule, the present composition allows for a relatively low level of microcapsules in the composition, whilst maintaining a comparable delivery efficiency of the microcapsules.

The liquid cleaning composition herein may be acidic or alkali or pH neutral, depending on the ingredients incorporated in the composition. The pH range of the liquid cleaning composition is preferably from 6 to 12, more preferably from 7 to 11, even more preferably from 8 to 10.

The liquid cleaning composition can have any suitable viscosity depending on factors such as formulated ingredients and purpose of the composition. In one embodiment, the composition has a high shear viscosity value, at a shear rate of 20/sec and a temperature of 21° C., of 200 to 3,000 cP, alternatively 300 to 2,000 cP, alternatively 500 to 1,000 cP, and a low shear viscosity value, at a shear rate of 1/sec and a temperature of 21° C., of 500 to 100,000 cP, alternatively 1000 to 10,000 cP, alternatively 1,500 to 5,000 cP.

### Soil Dispersant

The soil dispersant of the present invention comprises an alkylene amine backbone and a side chain bonded to the nitrogen atom of the alkylene amine backbone, wherein the side chain is of formula (I),

-(EO)_{b}(PO)_{c} (I)

wherein b represents the number of ethyleneoxy ( “EO”) units connecting to a nitrogen atom of the alkylene amine backbone and ranges from 3 to 60, and c represents the number of propyleneoxy (“PO”) units (if any) connecting to the EO units and ranges from 0 to 60. As discussed before, it is believed that due to the hydrophilic EO chain, the soil dispersant herein detaches clays from a treated fabric and prevents them from re-depositing onto the fabric.

The backbone used for the soil dispersant herein can be any suitable alkylene amines (e.g., ethylene amines, propylene amines), including quaternized and non-quaternized amines. The backbone can comprise a single alkylene amine or multiple alkylene amines as in a polymer (e.g., polyalkyleneimine) In the execution of the multiple alkylene amines as the backbone, at least one nitrogen atom of the backbone is bonded by side chain of formula (I), preferably multiple nitrogen atoms of the backbone are each bonded by side chain of formula (I), i.e., there are multiple side chains of formula (I) present in the soil dispersant molecule. When bonded by side chain of formula (I), a nitrogen atom can be bonded by one or two side chains of formula (I) depending on whether the nitrogen atom is at an internal position or at a terminal position of the backbone. In term of the number of the side chains in the soil dispersant molecule, there can be from one to hundreds, depending on factors including the size of the backbone, the number of available nitrogen atoms in the backbone, etc. For example, in the polyalkyleneimine execution, the number of the side chains can be from one or hundreds, preferably from 5 to 80, alternatively from 10 to 50.

Preferably, the soil dispersant herein comprises a compound selected from the group consisting of:

a) a polyethyleneimine ethoxylate, having polyethyleneimine (PEI) as a backbone and a side chain of formula (I) bonded to a nitrogen atom of the PEI backbone, preferably two or more side chains of formula (I) bonded to two or more nitrogen atoms of the PEI backbone, respectively,

-(EO)_{b}(PO)_{c} (I)

wherein b ranges from 3 to 60, and c ranges from 0 to 60;

b) a compound of formula (II),

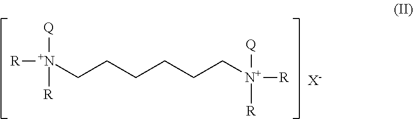

wherein R is an ethyleneoxy unit of formula (III):

-(EO)ₙR⁴ (III)

wherein n ranges from 3 to 50; R⁴ is hydrogen, an anionic unit, or a combination thereof;

Q is a quaternizing unit independently selected from the group consisting of C₁-C₈ linear alkyl, C₃-C₈ branched alkyl, benzyl, and mixtures thereof; and X is a water soluble anion; and

a combination thereof.

Polyethyleneimine Ethoxylate

In the polyethyleneimine ethoxylate, the PEI backbone can be either linear or cyclic or the combination thereof. The PEI backbone can also comprise PEI branching chains to a greater or lesser degree. In general, the PEI backbone described herein are modified in such a manner that each nitrogen atom of the PEI chain is thereafter described in terms of a unit that is substituted, quaternized, oxidized, or combinations thereof. The PEI backbone has an average number-average molecular weight, MWₙ, prior to modification and exclusive of the side chains, ranging from about 100 to about 100,000, preferably from about 200 to about 10,000, more preferably from 300 to about 3,000.

Without wishing to be bound by theory, it is believed that in typical wash conditions where the pH of the laundry liquor is around 8, the nitrogen moieties of the PEI backbone is partially protonated. Such, during the wash cycle, the PEI backbone deposits onto soils (e.g., clays) and penetrates imperfections such as cracks and crevasses. The penetration of the PEI backbone, in combination with the hydrophilic ethyleneoxy chain that extends outward from the soil surface, further enhances the clay removal performance.

In formula (I),

-(EO)_{b}(PO)_{c} (I)

b represents the average number of EO units per nitrogen atom in the PEI backbone and ranges from 3 to 60, preferably from 5 to 50, more preferably from 15 to 35; and c represents the average number of PO units per nitrogen atom in the PEI backbone and ranges from 0 to 60.

The polyethyleneimine ethoxylate herein can be divided to two sub-groups depending on the value of c in formula (I): when c is 0, and when c ranges from 1 to 60.

In the execution where c is 0, the compound does not have a PO unit. This type of compound and the manufacturing process thereof are generally described in U.S. Pat. No. 6,087,316. One preferred example of such type of soil dispersant is a polyethyleneimine corresponding to formula (I) having a PEI backbone with an average number-average molecular weight of about 600 which is ethoxylated to a level of about 20 EO units per PEI nitrogen atom.

Alternatively in the execution when c is from 1 to 60, the compound has one or more PO units. The PO unit is hydrophobic and therefore renders the soil dispersant an amphiphilic property, in combination with the hydrophilic EO chain. By adjusting the number of the EO and PO units in the compound, the compound herein can achieve balanced hydrophilic and hydrophobic properties, thereby boosting overall cleaning on surfactant sensitive stains such as grease/oils. In one embodiment, c ranges from 5 to 40, preferably from 10 to 25. This type of compound and the manufacturing process thereof are generally described in U.S. Pat. No. 8,097,579. One preferred embodiment of such type of soil dispersant is a polyethyleneimine corresponding to Formula (I) having a PEI backbone with an average number-average molecular weight of about 600 which is ethoxylated to a level of about 24 EO units per PEI nitrogen atoms and propoxylated to a level of about 16 PO units per PEI nitrogen atom.

These PEI backbones can be prepared, for example, by polymerizing ethyleneimine in the presence of a catalyst such as carbon dioxide, sodium bisulfite, sulfuric acid, hydrogen peroxide, hydrochloric acid, acetic acid, and the like. Specific methods for preparing these PEI backbones are disclosed in U.S. Pat. No. 2,182,306, Ulrich et al., issued Dec. 5, 1939; U.S. Pat. No. 3,033,746, Mayle et al., issued May 8, 1962; U.S. Pat. No. 2,208,095, Esselmann et al., issued Jul. 16, 1940; U.S. Pat. No. 2,806,839, Crowther, issued Sep. 17, 1957; and U.S. Pat. No. 2,553,696, Wilson, issued May 21, 1951. The PEI backbones are then modified by ethoxylation and optional propoxylation to obtain the polyethyleneimine ethoxylate.

Compound of Formula (II)

The compound of formula (II) is a zwitterionic hexamethylene diamine, comprising a quaternized diamine backbone and extended EO chains. Such a zwitterionic hexamethylene diamine and the manufacturing process thereof are generally described in U.S. Pat. No. 6,444,633. Without wishing to be bound by theory, it is believed that the quaternized diamine backbone absorbs effectively onto clay platelets while the EO chains detach clays and stabilizes the detached clays from re-desposition.

In formula (II),

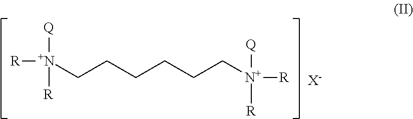

R is an ethyleneoxy unit of formula (IV):

-(EO)ₙR⁴ (III)

wherein n represents the average number of EO units and ranges from 3 to 50. Depending upon the method by which the formulator chooses to form the EO units, the wider or narrower the range of EO units present. Preferably the range of EO units in plus or minus two units, more preferably plus or minus one unit. Most preferably each R group comprises the same number of EO units. The index n is preferably from 10 to 40, more preferably from 15 to 35. A preferred value for n is 24;

R⁴ is hydrogen, an anionic unit, or a combination thereof. Non-limiting examples of anionic units include —(CH₂)ₚCO₂M; —(CH₂)_{q}SO₃M; —(CH₂)_{q}CH(SO₂M)-CH₂SO₃M; —(CH₂)_{q}CH(OSO₂M)CH₂OSO₃M; —(CH₂)_{q}CH(SO₃M)CH₂SO₃M; —(CH₂)ₚPO₃M; —PO₃M; and mixtures thereof; wherein M is hydrogen or a water soluble cation in sufficient amount to satisfy charge balance. Preferred anionic units are —(CH₂)ₚCO₂M or —(CH₂)_{q}SO₃M, more preferably —(CH₂)_{q}SO₃M. The indices p and q are integers from 0 to 6. Preferably from about 85%, more preferably from about 90%, most preferably from about 95% of all R⁴ units which comprise an aggregate sample of the zwitterionic diamine have R⁴ units which are anionic units. It will be understood by the formulator that some molecules will be fully capped with anionic units, while some molecules may have two R⁴ units which are hydrogen. However, most preferably from about 95% of all R units present will be capped with one or more anionic units described herein;

Q is a quaternizing unit independently selected from the group consisting of C₁-C₈ linear alkyl, C₃-C₈ branched alkyl, benzyl, and mixtures thereof, preferably is methyl or benzyl, most preferably is methyl; and

X is a water soluble anion in sufficient amount to provide electronic neutrality. To a great degree, the counter ion X will be derived from the unit which is used to perform the quaternization. For example, if methyl chloride is used as the quaternizing agent, chlorine (chloride ion) will be the counter ion X. Bromine (bromide ion) will be the dominant counter ion in the case where benzyl bromide is the quaternizing agent.

A preferred zwitterionic hexamethylene diamine is of formula (IV):

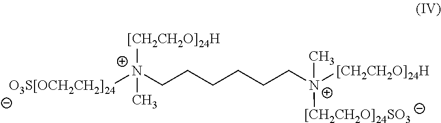

wherein the water soluble anion can comprise any suitable counterion.

### Microcapsule

The microcapsule of the present invention comprises a shell comprising an outer surface, a core encapsulated within the shell, and a coating coating the outer surface, wherein the coating is cationically charged. Typically, the shell is a solid material with well defined boundaries, while the coating that adheres to the shell may not have a clear boundary, particularly in an execution of polymer-coated microcapsule that is described below. The term “cationically charged” herein means that the coating per se is cationic (e.g., by containing a cationic polymer or a cationic ingredient) and does not necessarily mean that the shell is cationic too. Instead, many known microcapsules have anionic shells, e.g., melamine formaldehyde. These microcapsules having anionic shells can be coated with a cationic coating and thus fall within the scope of the microcapsule of the present invention. Preferably the coating comprises an efficiency polymer. The term “polymer” herein can be either homopolymers polymerized by one type of monomer or copolymers polymerized by two or more different monomers. The efficiency polymer herein can be either cationic or neutral or anionic, but preferably is cationic. In the execution that the efficiency polymer is anionic or neutral, the coating comprises other ingredients that render its cationic charge. In the execution that the efficiency polymer is cationic, the polymer may comprise monomers that are neutral or anionic, as long as the overall charge of the polymer is cationic. Such a polymer-coated microcapsule and the manufacturing process thereof are described in U.S. Patent Application No. 2011/0111999A.

The core of the microcapsule herein comprises a benefit agent, typically selected from those ingredients that are desired to deliver improved longevity or that are incompatible with other ingredients in a liquid cleaning composition. The benefit agent is preferably selected from the group consisting of perfume oil, silicone, wax, brightener, dye, insect repellant, vitamin, fabric softening agent, paraffin, enzyme, anti-bacterial agent, bleach, and a combination thereof. In one preferred embodiment, the core comprises a perfume oil. This perfume-encapsulated microcapsule is known as “perfume microcapsule” (“PMC”). PMC are described in the following references: US 2003/215417 A1; US 2003/216488 A1; US 2003/158344 A1; US 2003/165692 A1; US 2004/071742 A1; US 2004/071746 A1; US 2004/072719 A1; US 2004/072720 A1; EP 1,393,706 A1; US 2003/203829 A1; US 2003/195133 A1; US 2004/087477 A1; US 2004/0106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; U.S. RE 32,713; U.S. Pat. No. 4,234,627.

In the PMC execution, the encapsulated perfume oil can comprise a variety of perfume raw materials depending on the nature of the product. For example, when the product is a liquid laundry detergent, the perfume oil may comprise one or more perfume raw materials that provide improved perfume performance under high soil conditions and in cold water. In one embodiment, the perfume oil comprises an ingredient selected from the group consisting of allo-ocimene, allyl caproate, allyl heptoate, amyl propionate, anethol, anisic aldehyde, anisole, benzaldehyde, benzyl acetate, benzyl acetone, benzyl alcohol, benzyl butyrate, benzyl formate, benzyl iso valerate, benzyl propionate, beta gamma hexenol, camphene, camphor, carvacrol, laevo-carveol, d-carvone, laevo-carvone, cinnamyl formate, citral (neral), citronellol, citronellyl acetate, citronellyl isobutyrate, citronellyl nitrile, citronellyl propionate, cuminic alcohol, cuminic aldehyde, Cyclal C, cyclohexyl ethyl acetate, decyl aldehyde, dihydro myrcenol, dimethyl benzyl carbinol, dimethyl benzyl carbinyl acetate, dimethyl octanol, diphenyl oxide, ethyl acetate, ethyl aceto acetate, ethyl amyl ketone, ethyl benzoate, ethyl butyrate, ethyl hexyl ketone, ethyl phenyl acetate, eucalyptol, eugenol, fenchyl acetate, fenchyl alcohol, flor acetate (tricyclo decenyl acetate), frutene (tricyclo decenyl propionate), gamma methyl ionone, gamma-n-methyl ionone, gamma-nonalactone, geraniol, geranyl acetate, geranyl formate, geranyl isobutyrate, geranyl nitrile, hexenol, hexenyl acetate, cis-3-hexenyl acetate, hexenyl isobutyrate, cis-3-hexenyl tiglate, hexyl acetate, hexyl formate, hexyl neopentanoate, hexyl tiglate, hydratropic alcohol, hydroxycitronellal, indole, isoamyl alcohol, alpha-ionone, beta-ionone, gamma-ionone, alpha-irone, isobornyl acetate, isobutyl benzoate, isobutyl quinoline, isomenthol, isomenthone, isononyl acetate, isononyl alcohol, para-isopropyl phenylacetaldehyde, isopulegol, isopulegyl acetate, isoquinoline, cis-jasmone, lauric aldehyde (dodecanal), Ligustral, d-limonene, linalool, linalool oxide, linalyl acetate, linalyl formate, menthone, menthyl acetate, methyl acetophenone, methyl amyl ketone, methyl anthranilate, methyl benzoate, methyl benzyl acetate, methyl chavicol, methyl eugenol, methyl heptenone, methyl heptine carbonate, methyl heptyl ketone, methyl hexyl ketone, alpha-iso “gamma” methyl ionone, methyl nonyl acetaldehyde, methyl octyl acetaldehyde, methyl phenyl carbinyl acetate, methyl salicylate, myrcene, neral, nerol, neryl acetate, nonyl acetate, nonyl aldehyde, octalactone, octyl alcohol (octanol-2), octyl aldehyde, orange terpenes (d-limonene), para-cresol, para-cresyl methyl ether, para-cymene, para-methyl acetophenone, phenoxy ethanol, phenyl acetaldehyde, phenyl ethyl acetate, phenyl ethyl alcohol, phenyl ethyl dimethyl carbinol, alpha-pinene, beta-pinene, prenyl acetate, propyl butyrate, pulegone, rose oxide, safrole, alpha-terpinene, gamma-terpinene, 4-terpinenol, alpha-terpineol, terpinolene, terpinyl acetate, tetrahydro linalool, tetrahydro myrcenol, tonalid, undecenal, veratrol, verdox, vertenex, viridine, and a combination thereof.

The shell of the microcapsule herein preferably comprises a material selected from the group consisting of aminoplast, polyacrylate, polyethylene, polyamide, polystyrene, polyisoprenes, polycarbonates, polyester, polyolefin, polysaccharide (e.g., alginate or chitosan), gelatin, shellac, epoxy resin, vinyl polymer, water insoluble inorganic, silicone, and a combination thereof. Preferably, the shell comprises a material selected from the group consisting of aminoplast, polyacrylate, and a combination thereof.

Preferably, the shell of the microcapsule comprises an aminoplast. A method for forming such shell microcapsules includes polycondensation Aminoplast resins are the reaction products of one or more amines with one or more aldehydes, typically formaldehyde. Non-limiting examples of suitable amines include urea, thiourea, melamine and its derivates, benzoguanamine and acetoguanamine and combinations of amines. Suitable cross-linking agents (e.g., toluene diisocyanate, divinyl benzene, butanediol diacrylate etc.) may also be used and secondary wall polymers may also be used as appropriate, e.g. anhydrides and their derivatives, particularly polymers and co-polymers of maleic anhydride as disclosed in W0 02/074430. In one embodiment, the shell comprises a material selected from the group consisting of a urea formaldehyde, a melamine formaldehyde, and a combination thereof, preferably comprises a melamine formaldehyde (cross-linked or not).

In one preferred embodiment, the core comprises a perfume oil and the shell comprises a melamine formaldehyde. Alternatively, the core comprises a perfume oil and the shell comprises a melamine formaldehyde and poly(acrylic acid) and poly(acrylic acid-co-butyl acrylate).

The microcapsule of the present invention should be friable in nature. Friability refers to the propensity of the microcapsule to rupture or break open when subjected to direct external pressures or shear forces or heat. In the PMC execution, the perfume oil within the microcapsules of the present invention surprisingly maximizes the effect of the microcapsule bursting by providing a perfume that “blooms” upon the microcapsule rupturing.

In one preferred embodiment, the efficiency polymer is of formula (V),

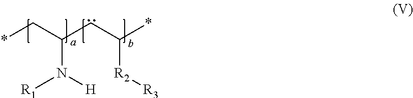

wherein:

a) a and b each independently range from 50 to 100,000;

b) each R¹ is independently selected from H, CH₃, (C═O)H, alkylene, alkylene with unsaturated C—C bonds, CH₂—CROH, (C═O)—NH-R, (C═O)—(CH₂)ₙ—OH, (C═O)-R, (CH₂)ₙ-E, —(CH₂—CH(C═O))ₙ—XR, —(CH₂)ₙ—COOH, —(CH₂)ₙ—NH₂, or —CH₂)ₙ—(C═O)NH₂, the index n ranges from 0 to 24, E is an electrophilic group, R is a saturated or unsaturated alkane, dialkylsiloxy, dialkyloxy, aryl, or alkylated aryl, preferably further containing a moiety selected from the group consisting of cyano, OH, COOH, NH₂, NHR, sulfonate, sulphate, —NH₂, quaternized amine, thiol, aldehyde, alkoxy, pyrrolidone, pyridine, imidazol, imidazolinium halide, guanidine, phosphate, monosaccharide, oligo, polysaccharide, and a combination thereof;

c) R² or R³ is absent or present:
(i) when R³ is present each R² is independently selected from —NH₂, —COO—, —(C═O)—, —O—, —S—, —NH—(C═O)—, —NR₁—, dialkylsiloxy, dialkyloxy, phenylene, naphthalene, or alkyleneoxy; and each R³ is independently selected from the same group as R¹;
(ii) when R³ is absent each R² is independently selected from —NH₂, —COO—, —(C═O)—, —O—, —S—, —NH—(C═O)—, —NR₁—, dialkylsiloxy, dialkyloxy, phenylene, naphthalene, or alkyleneoxy; and
(iii) when R² is absent, each R³ is independently selected the same group as R¹; and

wherein the efficiency polymer has an average molecular mass from about 1,000 Da to about 50,000,000 Da; a hydrolysis degree of from about 5% to about 95%; and/or a charge density from about 1 meq/g to about 23 meq/g.

In one embodiment, the efficiency polymer has:

a) an average molecular mass from 1,000 Da to 50,000,000 Da, alternatively from 5,000 Da to 25,000,000 Da, alternatively from 10,000 Da to 10,000,000 Da, alternatively from 340,000 Da to 1,500, 000 Da;

b) a hydrolysis degree of from 5% to 95%, alternatively from 7% to 60%, alternatively from 10% to 40%; and/or

c) a charge density from 1 meq/g to 23 meq/g, from 1.2 meq/g to 16 meq/g, from 2 meq/g to about 10 meq/g, or even from 1 meq/g to about 4 meq/g.

In one embodiment, the efficiency polymer is selected from the group consisting of polyvinyl amine, polyvinyl formamide, polyallyl amine, and copolymers thereof. In one preferred embodiment, the efficiency polymer is polyvinyl formamide, commercially available from BASF AG of Ludwigshafen, Germany, under the name of Lupamin® 9030. In one embodiment, the efficiency polymer comprises a polyvinylamide-polyvinylamine copolymer.

Suitable efficiency polymers such as polyvinylamide-polyvinylamine copolymers can be produced by hydrolization of the polyvinylformamide starting polymer. Suitable efficiency polymers can also be formed by copolymerisation of vinylformamide with arcylamide, acrylic acid, acrylonitrile, ethylene, sodium acrylate, methyl acrylate, maleic anhydride, vinyl acetate, n-vinylpyrrolidine. Suitable efficiency polymers or oligomers can also be formed by cationic polymerisation of vinylformamide with protonic acids, such as methylsulfonic acid, and or Lewis acids, such as boron trifluoride.

Particle size and average diameter of the microcapsules can vary from 1 micrometer to 100 micrometers, alternatively from 5 micrometers to 80 microns, alternatively from 10 micrometers to 75 micrometers, and alternatively between 15 micrometers to 50 micrometers. The particle size distribution can be narrow, broad, or multimodal. Multimodal distributions may be composed of different types of capsule chemistries.

In one embodiment, the microcapsule utilized herein generally has an average shell thickness ranging from 0.1 micron to 30 microns, alternatively from 1 micron to 10 microns. In one embodiment, the microcapsule herein has a coating to shell ratio in terms of thickness of from 1:200 to about 1:2, alternatively from 1:100 to 1:4, alternatively from 1:80 to about 1:10, respectively.

The microcapsule can be combined with the composition at any time during the preparation of the liquid cleaning composition. The microcapsule can be added to the composition or vice versa. For example, the microcapsule may be post dosed to a pre-made composition or may be combined with other ingredients such as water, during the preparation of the composition.

The microcapsule herein may be contained in a microcapsule slurry. In the context of the present invention, a microcapsule slurry is defined as a watery dispersion, preferably comprising from 10% to 50%, alternatively from 20% to 40%, by weight of the slurry, of the microcapsules.

The microcapsule slurry herein can comprise a water-soluble salt. The term “water-soluble salt” herein means water-soluble ionic compounds, composed of dissociated positively charged cations and negatively charged anions. It is defined as the solubility in demineralised water at ambient temperature and atmospheric pressure. The microcapsule slurry may comprise from 1 mmol/kg to 750 mmol/kg, alternatively from 10 mmol/kg to 300 mmol/kg, of the water-soluble salt. In one embodiment, the water-soluble salt can be present as a residual impurity of the microcapsule slurry. This residual impurity can be from other ingredients in the microcapsule slurry, which are purchased from various suppliers. Alternatively, the water-soluble salt is intentionally added to the microcapsule slurry to adjust the rheology profile of the microcapsule slurry, thereby improving the stability of the slurry during transport and long-term storage.

Preferably, the water-soluble salt present in the microcapsule slurry is formed of polyvalent cations selected from alkaline earthmetals, transition metals or metals, together with suitable monoatomic or polyatomic anions. In one embodiment, the water-soluble salt comprises cations, the cations being selected from the group consisting of Beryllium, Magnesium, Calcium, Strontium, Barium, Scandium, Titan, Iron, Copper, Aluminium, Zinc, Germanium, and Tin, preferably are Magnesium. In one embodiment, the water-soluble salt comprises anions, the anions being selected from the group consisting of Fluorine, Chlorine, Bromine, Iodine, Acetate, Carbonate, Citrate, hydroxide, Nitrate, Phosphite, Phosphate and Sulfate, preferably the anions are the monoatomic anions of the halogens. Most preferably, the water-soluble salt is magnesium chloride, and the magnesium chloride is preferably present in the slurry from 0.1% to 5%, preferably 0.2% to 3%, by weight of the slurry.

In one embodiment of a process of making a microcapsule slurry comprising: combining, in any order, a microcapsule (without a polymer coating yet), an efficiency polymer, and optionally a stabilization system, and optionally a biocide. Preferably, the efficiency polymer comprises polyvinyl formamide, and the stabilization system comprises magnesium chloride and xanthan gum. In one embodiment, the microcapsule and the efficiency polymer are permitted to be in intimate contact for at least 15 minutes, preferably for at least 1 hour, more preferably for at 4 hours before the slurry is used in a product, thereby forming a polymer coating coating the microcapsule.

Suitable microcapsules that can be turned into the polymer-coated microcapsules disclosed herein can be made in accordance with applicants' teaching, such as the teaching of US 2008/0305982 A1 and US 2009/0247449 A1. Alternatively, suitable polymer-coated capsules can be purchased from Appleton Papers Inc. of Appleton, Wis. USA.

### Adjunct Ingredient

The liquid cleaning composition herein may comprise one or more adjunct ingredients. Suitable adjunct ingredients include but are not limited to: anionic surfactants, nonionic surfactants, cationic surfactants, amphoteric surfactants, zwitterionic surfactants, fatty acids, builders, chelating agents, dye transfer inhibiting agents, dispersants, rheology modifiers, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, photobleaches, structure elasticizing agents, fabric softeners, carriers, hydrotropes, processing aids, solvents, hueing agents, anti-microbial agents, free perfume oils, silicone emulsion, and/or pigments. In addition to the disclosure below, suitable examples of such other adjunct ingredients and levels of use are found in U.S. Pat. Nos. 5,576,282, 6,306,812, and 6,326,348. The precise nature of these adjunct ingredients and the levels thereof in the liquid cleaning composition will depend on factors like the specific type of the composition and the nature of the cleaning operation for which it is to be used.

In one embodiment, the composition comprises an anionic surfactant. Non-limiting examples of anionic surfactants include: linear alkylbenzene sulfonate (LAS), preferably C₁₀-C₁₆ LAS; C₁₀-C₂₀ primary, branched-chain and random alkyl sulfates (AS); C₁₀-C₁₈ secondary (2,3) alkyl sulfates; sulphated fatty alcohol ethoxylate (AES), preferably C₁₀-C₁₈ alkyl alkoxy sulfates (AEₓS) wherein preferably x is from 1-30, more preferably x is 1-3; C₁₀-C₁₈ alkyl alkoxy carboxylates preferably comprising 1-5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242, and WO 99/05244; methyl ester sulfonate (MES); and alpha-olefin sulfonate (AOS). Preferably, the composition comprises an anionic surfactant selected from the group consisting of LAS, AES, AS, and a combination thereof, more preferably selected from the group consisting of LAS, AES, and a combination thereof. The total level of the anionic surfactant(s) may be from 5% to 95%, alternatively from 8% to 70%, alternatively from 10% to 50%, alternatively from 12% to 40%, alternatively from 15% to 30%, by weight of the liquid detergent composition.

In one embodiment, the composition herein comprises a nonionic surfactant. Non-limiting examples of nonionic surfactants include: C12-C18 alkyl ethoxylates, such as Neodol® nonionic surfactants available from Shell; C6-C12 alkyl phenol alkoxylates wherein the alkoxylate units are a mixture of ethyleneoxy and propyleneoxy units; C12-C18 alcohol and C6-C12 alkyl phenol condensates with ethylene oxide/propylene oxide block alkyl polyamine ethoxylates such as PLURONIC® available from BASF; C14-C22 mid-chain branched alcohols, BA, as discussed in U.S. Pat. No. 6,150,322; C14-C22 mid-chain branched alkyl alkoxylates, BAEx, wherein x is from 1-30, as discussed in U.S. Pat. No. 6,153,577, U.S. Pat. No. 6,020,303 and U.S. Pat. No. 6,093,856; alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408. Also useful herein as nonionic surfactants are alkoxylated ester surfactants such as those having the formula R1C(O)O(R2O)nR3 wherein R1 is selected from linear and branched C6-C22 alkyl or alkylene moieties; R2 is selected from C2H4 and C3H6 moieties and R3 is selected from H, CH3, C2H5 and C3H7 moieties; and n has a value between 1 and 20. Such alkoxylated ester surfactants include the fatty methyl ester ethoxylates (MEE) and are well-known in the art; see for example U.S. Pat. No. 6,071,873; U.S. Pat. No. 6,319,887; U.S. Pat. No. 6,384,009; U.S. Pat. No. 5,753,606; WO 01/10391, WO 96/23049. The preferred nonionic surfactant as a co-surfactant is C12-C15 alcohol ethoxylated with an average of 7 moles of ethylene oxide (e.g., Neodol®25-7 available from Shell).

In one embodiment, the composition herein comprises an amphoteric surfactant. Non-limiting examples of amphoteric surfactants include: derivatives of secondary and tertiary amines, derivatives of heterocyclic secondary and tertiary amines, or derivatives of quaternary ammonium, quaternary phosphonium or tertiary sulfonium compounds. Preferred examples include: betaine, including alkyl dimethyl betaine and cocodimethyl amidopropyl betaine, C8 to C18 (or C12 to C18) amine oxides and sulfo and hydroxy betaines, such as N-alkyl-N,N-dimethylammino-1-propane sulfonate where the alkyl group can be C8 to C18, or C10 to C14.

Preferably, the amphoteric surfactant herein is selected from water-soluble amine oxide surfactants. A useful amine oxide surfactant is:

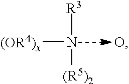

where R³ is a C₈₋₂₂ alkyl, a C₈₋₂₂ hydroxyalkyl, or a C₈₋₂₂ alkyl phenyl group; each R⁴ is a C₂₋₃ alkylene, or a C₂₋₃₂ hydroxyalkylene group; x is from 0 to about 3; and each R⁵ is a C₁₋₃ alkyl, a C₁₋₃ hydroxyalkyl, or a polyethylene oxide containing from about 1 to about 3 EOs. Preferably, the amine oxide surfactant may be a C₁₀₋₁₈ alkyl dimethyl amine oxide or a C₈₋₁₂ alkoxy ethyl dihydroxy ethyl amine oxide. Preferred amine oxides include linear C₁₀, lincear C₁₂, linear C₁₀₋₁₂, and linear C₁₂₋₁₄ alkyl dimethyl amine oxides.

In one embodiment, the composition herein comprises a rheology modifier (also referred to as a “structurant” in certain situations), which functions to suspend and stabilize the microcapsules and to adjust the viscosity of the composition so as to be more applicable to the packaging assembly. The rheology modifier herein can be any known ingredient that is capable of suspending particles and/or adjusting rheology to a liquid composition, such as those disclosed in U.S. Patent Application Nos. 2006/0205631A1, 2005/0203213A1, and U.S. Pat. Nos. 7,294,611, 6,855,680. Preferably the rheology modifier is selected from the group consisting of hydroxy-containing crystalline material, polyacrylate, polysaccharide, polycarboxylate, amine oxide, alkali metal salt, alkaline earth metal salt, ammonium salt, alkanolammonium salt, C₁₂-C₂₀ fatty alcohol, di-benzylidene polyol acetal derivative (DBPA), di-amido gallant, a cationic polymer comprising a first structural unit derived from methacrylamide and a second structural unit derived from diallyl dimethyl ammonium chloride, and a combination thereof.

Preferably, the rheology modifier is a hydroxy-containing crystalline material generally characterized as crystalline, hydroxyl-containing fatty acids, fatty esters and fatty waxes, such as castor oil and castor oil derivatives. More preferably the rheology modifier is a hydrogenated castor oil (HCO).

The rheology modifier can be present at any suitable level in the liquid cleaning composition. Preferably, the rheology modifier is present from 0.05% to 5%, preferably from 0.08% to 3%, more preferably from 0.1% to 1%, by weight of the composition, in the composition. In the HCO execution, the HCO is present from 0.05% to 1%, preferably from 0.1% to 0.5%, by weight of the composition, in the composition.

In one preferred embodiment, the liquid cleaning composition of the present invention comprises:

a) from 0.8% to 3%, by weight of the composition, of a soil dispersant selected from the group consisting of:

i) a polyethyleneimine ethoxylate having a PEI as a backbone and one or more side chains of formula (I) bonded to a nitrogen atom of the PEI backbone,

-(EO)_{b}(PO)_{c} (I)

wherein the polyethyleneimine ethoxylate has a PEI backbone of MWₙ ranging from about 300 to about 3,000; b ranges from 15 to 35; and c is 0 or c ranges from 10 to 25, but preferably is 0;

ii) compound of formula (IV),

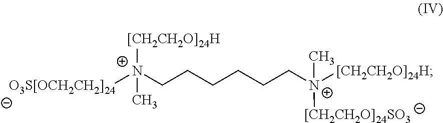

and a combination thereof.

b) from 0.11% to 0.25%, by weight of the composition, of a microcapsule, wherein the microcapsule comprises: a shell comprising an outer surface, a core encapsulated within the shell, and a coating coating the outer surface, wherein the coating is cationically charged, wherein coating comprises an efficient polymer that is a polyvinyl formamide; and

c) from 0.05% to 1%, by weight of the composition, of a hydrogenated castor oil.

In one preferred embodiment, the liquid cleaning composition of the present invention comprises:

a) from 0.8% to 3%, by weight of the composition, of a polyethyleneimine ethoxylate having a PEI as a backbone and one or more side chains of formula (I) bonded to a nitrogen atom of the PEI backbone,

-(EO)_{b}(PO)_{c} (I)

wherein the polyethyleneimine ethoxylate has a PEI backbone of MWₙ ranging from about 300 to about 3,000; b ranges from 15 to 35; and c is 0;

b) from 0.11% to 0.25%, by weight of the composition, of a microcapsule, wherein the microcapsule comprises: a shell comprising an outer surface, a core encapsulated within the shell, and a coating coating the outer surface, wherein the coating is cationically charged, wherein coating comprises an efficient polymer that is a polyvinyl formamide; and

c) from 0.05% to 1%, by weight of the composition, of a hydrogenated castor oil.

In an alternative preferred embodiment, the liquid cleaning composition of the present invention comprises:

a) from 0.8% to 3%, by weight of the composition, of a polyethyleneimine ethoxylate having a PEI as a backbone and one or more side chains of formula (I) bonded to a nitrogen atom of the PEI backbone,

-(EO)_{b}(PO)_{c} (I)

wherein the polyethyleneimine ethoxylate has a PEI backbone of MWₙ ranging from about 300 to about 3,000; b ranges from 15 to 35; and c ranges from 10 to 25;

b) from 0.11% to 0.25%, by weight of the composition, of a microcapsule, wherein the microcapsule comprises: a shell comprising an outer surface, a core encapsulated within the shell, and a coating coating the outer surface, wherein the coating is cationically charged, wherein coating comprises an efficient polymer that is a polyvinyl formamide; and

c) from 0.05% to 1%, by weight of the composition, of a hydrogenated castor oil.

In yet another preferred embodiment, the liquid cleaning composition of the present invention comprises:

a) from 0.8% to 3%, by weight of the composition, of a soil dispersant of formula (IV),

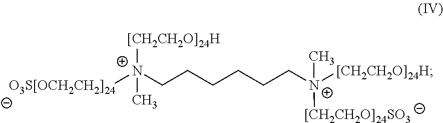

b) from 0.11% to 0.25%, by weight of the composition, of a microcapsule, wherein the microcapsule comprises: a shell comprising an outer surface, a core encapsulated within the shell, and a coating coating the outer surface, wherein the coating is cationically charged, wherein coating comprises an efficient polymer that is a polyvinyl formamide; and

c) from 0.05% to 1%, by weight of the composition, of a hydrogenated castor oil.

### Composition Preparation

The liquid cleaning composition of the present invention is generally prepared by conventional methods such as those known in the art of making liquid cleaning compositions. Such methods typically involve mixing the essential and optional ingredients in any desired order to a relatively uniform state, with or without heating, cooling, application of vacuum, and the like, thereby providing liquid cleaning compositions containing ingredients in the requisite concentrations.

### The Use

One aspect of the present invention is directed to the use of the aforementioned liquid cleaning composition for pretreating a fabric.

Another aspect of the present invention is directed to the use of a liquid cleaning composition for pretreating a fabric, wherein the composition comprises:

a) a soil dispersant comprising an ethylene imine and a repeating unit of formula (I),

-(EO)_{b}(PO)_{c} (I)

wherein b ranges from 3 to 60, and c ranges from 0 to 60; and

b) a microcapsule, wherein the microcapsule comprises a shell comprising an outer surface, a core encapsulated within the shell, and a coating coating the outer surface, wherein the coating is cationically charged. Preferably, the coating comprises an efficiency polymer of a polyvinyl formamide.

Preferably, in the composition, the soil dispersant is present from 0.5% to 5%, preferably from 0.6% to 4%, more preferably from 0.8% to 3%, by weight of the composition, and the microcapsule is present from 0.11% to 0.25%, preferably from 0.15% to 0.2%, by weight of the composition.

### Test Method

Method for Determining of Average Molecular Mass

The average molecular mass of a polymer is determined in accordance with ASTM Method D4001-93(2006).

Method for Determining of Hydrolysis Degree

The hydrolysis degree is determined in accordance with the method found in U.S. Pat. No. 6,132,558, column 2, line 36 to column 5, line 25.

Method for Determining of Charge Density

The charge density of a polymer is determined with the aid of colloid titration, cf. D. Horn, Progress in Colloid & Polymer Sci. 65 (1978), 251-264.

### EXAMPLE

The Examples herein are meant to exemplify the present invention but are not used to limit or otherwise define the scope of the present invention.

### Example 1A

### 84wt % Core/16wt % Wall Melamine Formaldehyde Perfume Microcapsule

25 grams of butyl acrylate-acrylic acid copolymer emulsifier (Colloid C351, 25% solids, pka 4.5-4.7, (Kemira Chemicals, Inc. Kennesaw, Ga. U.S.A.) is dissolved and mixed in 200 grams deionized water. The pH of the solution is adjusted to pH of 4.0 with sodium hydroxide solution. 8 grams of partially methylated methylol melamine resin (Cymel 385, 80% solids, (Cytec Industries West Paterson, N.J., U.S.A.)) is added to the emulsifier solution. 200 grams of perfume oil is added to the previous mixture under mechanical agitation and the temperature is raised to 50° C. After mixing at higher speed until a stable emulsion is obtained, the second solution and 4 grams of sodium sulfate salt are added to the emulsion. This second solution contains 10 grams of butyl acrylate-acrylic acid copolymer emulsifier (Colloid C351, 25% solids, pka 4.5-4.7, Kemira), 120 grams of distilled water, sodium hydroxide solution to adjust pH to 4.8, 25 grams of partially methylated methylol melamine resin (Cymel 385, 80% solids, Cytec). This mixture is heated to 70° C. and maintained overnight with continuous stirring to complete the encapsulation process. 23 grams of acetoacetamide (Sigma-Aldrich, Saint Louis, Mo., U.S.A.) is added to the suspension. An average capsule size of 30 um is obtained as analyzed by a Model 780 Accusizer.

### Example 1B

### Polymer-coated Perfume Microcapsule

Polymer-coated perfume microcapsules are prepared by weighing 99 g of melamine formaldehyde perfume microcapsules slurry obtained from Example 1A and 1 g of polyvinyl formamide (16% active, commercially available from BASF AG of Ludwigshafen, Germany, under the name of Lupamin® 9030) in a glass jar. The ingredients are shortly mixed with a spoon and are further mixed overnight in a shaker. Thus, a polymer-coated perfume microcapsule is obtained.

### Example 2

### Formulations of Liquid Laundry Detergent Compositions

TABLE 1

| | 2A | 2B | 2C | 2D | 2E | 2F |
|---|---|---|---|---|---|---|
| C₁₂-₁₄AE₁₋₃S | 6 | 6 | 6 | 13 | 8.5 | 6 |
| C₁₁-₁₃LAS | 6 | 6 | 6 | 3 | 5 | 6 |
| Neodol ®25-7 a | 4.2 | 4.2 | 4.2 | 1.4 | 1.0 | 4.2 |
| C₁₂-₁₄ alkyl dimethyl amine | 0.5 | 0.5 | 0.5 | 0 | 0.5 | 0.5 |
| oxide | | | | | | |
| Citric acid | 1.2 | 1.2 | 1.2 | 0 | 1.2 | 1.2 |
| Boric acid | 1.9 | 1.9 | 1.9 | 0 | 1.9 | 1.9 |
| C₁₂-C₁₈ fatty acid | 1 | 1 | 1 | 1.5 | 1 | 1 |
| Na-DTPA b | 0.2 | 0.2 | 0.2 | 0.06 | 0.2 | 0.2 |
| 1,2 propanediol | 2 | 2 | 2 | 0 | 2 | 2 |
| Calcium chloride | 0.03 | 0.03 | 0.03 | 0 | 0.03 | 0.03 |
| Sodium cumene sulphonate | 0.2 | 0.2 | 0.2 | 0 | 0.2 | 0.2 |
| Silicone (PDMS) emulsion | 0.0025 | 0.0025 | 0.0025 | 0 | 0.0025 | 0.0025 |
| Monoethanolamine | 0.096 | 0.096 | 0.096 | 0.07 | 0.096 | 0.096 |
| Sodium polyacrylate | 0 | 0 | 0 | 1.4 | 0 | 0 |
| NaOH | Up to pH 8 | Up to pH 8 | Up to pH 8 | Up to pH 8 | Up to pH 8 | Up to pH 8 |
| Brightener | 0.06 | 0.06 | 0.06 | 0 | 0.06 | 0.06 |
| Protease | 0.3 | 0.3 | 0.3 | 0 | 0.3 | 0.3 |
| Amylase | 0.04 | 0.04 | 0.04 | 0 | 0.04 | 0.04 |
| Dye | 0.002 | 0.002 | 0.002 | 0 | 0.002 | 0.002 |
| Neat perfume oil | 0.6 | 0.6 | 0.6 | 0 | 0.6 | 0.6 |
| Perfume microcapsule of | 0.2 | 0.2 | 0.2 | 0.2 | 0.2 | 0.2 |
| Example 1B | | | | | | |
| Polyethyleneimine | 2 | 0 | 0 | 1 | 1 | 0 |
| ethoxylate c | | | | | | |
| Polyethyleneimine | 0 | 0 | 1 | 0 | 1 | 2 |
| ethoxylate d | | | | | | |
| Zwitterionic hexamethylene | 0.46 | 2.46 | 0 | 0 | 0.46 | 0.46 |
| diamine e | | | | | | |
| Hydrogenated castor oil | 0.12 | 0.12 | 0.12 | 0.12 | 0.12 | 0.12 |
| Water | Add to 100 | Add to 100 | Add to 100 | Add to 100 | Add to 100 | Add to 100 |
| | 2G | 2H | 2I | 2J | 2K | 2L |
| C₁₂-₁₄AE₁₋₃S | 11.2 | 11.2 | 6.81 | 7.88 | 8.5 | 5-13 |
| C₁₁-₁₃LAS | 6.5 | 1.9 | 4.52 | 4.6 | 5 | 1-8 |
| Neodol ®25-7 a | 0.83 | 0.63 | 1 | 0.63 | 1 | 0-2 |
| C₁₂-₁₄ alkyl dimethyl | 0.66 | 0 | 0 | 0.3 | 0.5 | 0-1 |
| amine oxide | | | | | | |
| Citric acid | 1.27 | 1.2 | 1.2 | 1.2 | 1.5 | 1.2 |
| Boric acid | 2.6 | 2.1 | 2.1 | 2.1 | 1.7 | 2.1 |
| C₁₂-C₁₈ fatty acid | 0.86 | 1 | 1 | 1 | 0.6 | 0-2 |
| Na-DTPA b | 0.24 | 0.19 | 0.19 | 0.19 | 0.3 | 0.19 |
| 1,2 propanediol | 1.54 | 1.21 | 1.21 | 1.21 | 3 | 0-5 |
| Calcium chloride | 0 | 0 | 0 | 0 | 0 | 0 |
| Sodium cumene sulphonate | 0 | 0 | 0 | 0 | 0.3 | 0-1 |
| Silicone (PDMS) emulsion | 0.0025 | 0.0025 | 0.0025 | 0.0025 | 0 | 0.0025 |
| Monoethanolamine | 0.12 | 0.096 | 0.096 | 0.096 | 0 | 0.096 |
| Sodium polyacrylate | 0 | 0 | 0 | 0 | 0 | 0 |
| NaOH | up to pH 8 | up to pH 8 | up to pH 8 | up to pH 8 | Up to pH 8 | up to pH 8 |
| Brightener | 0.072 | 0.057 | 0.057 | 0.057 | 0.06 | 0-0.1 |
| Protease | 0 | 0 | 0 | 0 | 0.3 | 0-0.5 |
| Amylase | 0 | 0 | 0 | 0 | 0.04 | 0-0.5 |
| Dye | 0.0012 | 0.0012 | 0.0012 | 0.0012 | 0.002 | 0.0012 |
| Neat perfume oil | 0.55 | 0.55 | 0.55 | 0.55 | 0.6 | 0.2-0.8 |
| Perfume microcapsule | 0.19 | 0.15 | 0.15 | 0.15 | 0.2 | 0.11-0.25 |
| of Example 1B | | | | | | |
| Polyethyleneimine | 1.27 | 0.5 | 1 | 0.85 | 1 | 0.2-2 |
| ethoxylate c | | | | | | |
| Polyethyleneimine | 1.27 | 0.5 | 1 | 0.85 | 1 | 0.2-2 |
| ethoxylate d | | | | | | |
| Zwitterionic | 0 | 0 | 0 | 0 | 0 | 0-1 |
| hexamethylene diamine e | | | | | | |
| Hydrogenated castor oil | 0.15 | 0.12 | 0.12 | 0.12 | 0.12 | 0.12 |
| Water | add to 100 | add to 100 | add to 100 | add to 100 | add to 100 | add to 100 |

a Neodol ®25-7 is C₁₂-C₁₅ alcohol ethoxylated with an average of 7 moles of ethylene oxide as a nonionic surfactant, available from Shell
b penta sodium salt diethylene triamine penta acetic acid as a chelant
c polyethyleneimine ethoxylate having a PEI backbone of MWₙ of about 600 and side chains of (EO)₂₀
d polyethyleneimine ethoxylate having a PEI backbone of MWₙ of about 600 and side chains of (EO)₂₄(PO)₁₆.
e zwitterionic hexamethylene diamine of formula (IV)

### Preparation of the Composition of Examples 2A-2L:

The liquid detergent compositions of Examples 2A-2L are prepared by the following steps:

a) mixing a combination of NaOH and water in a batch container by applying a shear of 200 rpm;

b) adding citric acid (if any), boric acid (if any), C₁₁-C₁₃ LAS, and NaOH into the batch container, keeping on mixing by applying a shear of 200 rpm;

c) cooling down the temperature of the combination obtained in step b) to 25° C.;

d) adding C₁₂₋₁₄AE₁₋₃S, Na-DTPA, Neodol®25-7, C₁₂-C₁₈ fatty acid, 1,2 propanediol (if any), C₆-C₁₅ alkyl dimethyl amine oxide (if any), and calcium chloride (if any), sodium cumene sulphonate (if any), silicone emulsion (if any), sodium polyacrylate (if any), polyethyleneimine ethoxylate having side chains of (EO)₂₀ (if any), polyethyleneimine ethoxylate having side chains of (EO)₂₄(PO)₁₆ (if any), zwitterionic hexamethylene diamine of formula (IV) (if any) into the batch container, mixing by applying a shear of 250 rpm until the combination is homogeneously mixed, and adjusting pH to 8;

e) adding brightener (if any), protease (if any), amylase (if any), dye (if any), and neat perfume oil (if any) into the batch container, mixing by applying a shear of 250 rpm;

f) adding perfume microcapsule obtained in Example 1B, and mixing by applying a shear of 250 rpm for 1 minute; and

g) adding monoethanolamine and hydrogenated castor oil into the batch container, thus forming a liquid laundry detergent composition,

wherein each ingredient in the composition is present in the level as specified for Examples 2A-2L in Table 1.

### Example 3

### Exemplary Liquid Detergent Compositions for Use in Unit Dose (UD) Products

The following liquid detergent compositons are prepared and encapsulated in a multi-compartment pouch formed by a polyvinyl alcohol-film.

TABLE 2

| | 3A |
|---|---|
| C₁₂-₁₄AE₁₋₃S | 7.5 |
| C₁₁-₁₃LAS | 15 |
| Neodol ®25-7 a | 13 |
| C₁₂-₁₄ alkyl dimethyl amine oxide | 0.5-2.0 |
| Citric acid | 0.6 |
| C₁₂-C₁₈ fatty acid | 15 |
| 1,2 propanediol | 17 |
| Calcium chloride | 0.1 |
| NaOH | Up to pH 8 |
| Brightener | 0.2 |
| Protease | 0.06 |
| Amylase | 0.005 |
| Neat perfume oil | 1.5 |
| Perfume microcapsule of Example | 0.1-0.25 |
| 1B | |
| Polyethyleneimine ethoxylate c | 0-6 |
| Polyethyleneimine ethoxylate d | 0-6 |
| Hydrogenated castor oil | 0.15 |
| Water | Add to 100% |

Unless otherwise indicated, all percentages, ratios, and proportions are calculated based on weight of the total composition. All temperatures are in degrees Celsius (° C.) unless otherwise indicated. All measurements made are at 25° C., unless otherwise designated. All component or composition levels are in reference to the active level of that component or composition, and are exclusive of impurities, for example, residual solvents or by-products, which may be present in commercially available sources.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid cleaning composition, comprising:
a) from about 0.5% to about 5%, by weight of the composition, of a soil dispersant comprising an alkylene amine backbone and a side chain bonded to the nitrogen atom of the alkylene amine backbone, wherein the side chain is of formula (I),
-(EO)_{b}(PO)_{c} (I)
wherein b ranges from 3 to 60, and c ranges from 0 to 60; and
b) from about 0.11% to about 0.25%, by weight of the composition, of a microcapsule, wherein said microcapsule comprises: a shell comprising an outer surface, a core encapsulated within said shell, and a coating coating said outer surface, wherein said coating is cationically charged.

2. The composition according to claim 1, wherein said soil dispersant comprises a compound selected from the group consisting of:
a polyethyleneimine ethoxylate, having a polyethyleneimine (PEI) as a backbone and a side chain of formula (I) bonded to a nitrogen atom of the PEI backbone
-(EO)_{b}(PO)_{c} (I)
wherein b ranges from 3 to 60, and c ranges from 0 to 60;
a compound of formula (II), 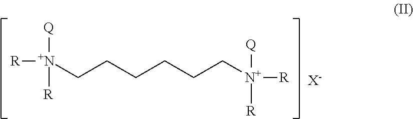
wherein R is an ethyleneoxy unit of formula (III):
-(EO)ₙR⁴ (III)
wherein n ranges from 10 to 40; R⁴ is hydrogen, an anionic unit, or a combination thereof Q is a quaternizing unit independently selected from the group consisting of C₁-C₈ linear alkyl, C₃-C₈ branched alkyl, benzyl, and mixtures thereof; and X is a water soluble anion; and
a combination thereof.

3. The composition according to claim 2, wherein the polyethyleneimine ethoxylate has a PEI backbone of an average number-average molecular weight, MWₙ, ranging from about 300 to about 3,000; b ranges from 15 to 35; and c is 0.

4. The composition according to claim 2, wherein the polyethyleneimine ethoxylate has a PEI backbone of MWₙ ranging from about 300 to about 3,000; b ranges from 15 to 35; and c ranges from 10 to 25.

5. The composition according to claim 2, wherein compound of formula (III) is of formula (IV):

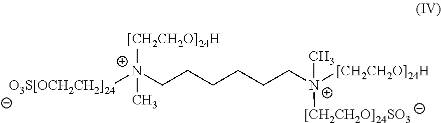

6. The composition according to claim 1, wherein said shell comprises a melamine formaldehyde.

7. The composition according to claim 1, wherein said coating comprises an efficiency polymer of formula (V): 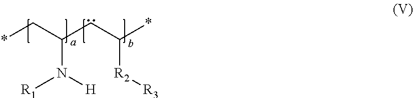
wherein:
d) a and b each independently range from about 50 to about 100,000;
e) each R¹ is independently selected from H, CH₃, (C═O)H, alkylene, alkylene with unsaturated C—C bonds, CH₂—CROH, (C═O)—NH—R, (C═O)—(CH₂)ₙ—OH, (C═O)—R, (CH₂)ₙ-E, —(CH₂—CH(C═O))ₙ—R, —(CH₂)ₙ—COOH, —(CH₂)ₙ—NH₂, or —CH₂)ₙ—(C═O)NH₂, the index n ranges from 0 to 24, E is an electrophilic group, R is a saturated or unsaturated alkane, dialkylsiloxy, dialkyloxy, aryl, or alkylated aryl, further containing a moiety selected from the group consisting of cyano, OH, COOH, NH₂, NHR, sulfonate, sulphate, —NH₂, quaternized amine, thiol, aldehyde, alkoxy, pyrrolidone, pyridine, imidazol, imidazolinium halide, guanidine, phosphate, monosaccharide, oligo, polysaccharide, and a combination thereof;
f) R² or R³ is absent or present:
(i) when R³ is present each R² is independently selected from —NH₂, —COO—, —(C═O)—, —O—, —S—, —NH—(C═O)—, —NR₁—, dialkylsiloxy, dialkyloxy, phenylene, naphthalene, or alkyleneoxy; and each R³ is independently selected the same group as R¹;
(ii) when R³ is absent each R² is independently selected from —NH₂, —COO—, —(C═O)—, —O—, —S—, —NH—(C═O)—, —NR₁—, dialkylsiloxy, dialkyloxy, phenylene, naphthalene, or alkyleneoxy; and
(iii) when R² is absent, each R³ is independently selected the same group as R¹; and
wherein said efficiency polymer has: an average molecular mass from about 1,000 Da to about 50,000,000 Da; a hydrolysis degree of from about 5% to about 95%; and/or a charge density from about 1 meq/g to about 23 meq/g.

8. The composition according to claim 7, wherein said efficiency polymer is selected from the group consisting of polyvinyl amine, polyvinyl formamide, polyallyl amine, and copolymers thereof.

9. The composition according to claim 1, wherein said core comprises a perfume oil.

10. The composition according to claim 1, further comprising a rheology modifier selected from the group consisting of hydroxy-containing crystalline material, polyacrylate, polysaccharide, polycarboxylate, alkali metal salt, alkaline earth metal salt, ammonium salt, alkanolammonium salt, C₁₂-C₂₀ fatty alcohol, di-benzylidene polyol acetal derivative, di-amido gallant, a cationic polymer comprising a first structural unit derived from methacrylamide and a second structural unit derived from diallyl dimethyl ammonium chloride, and a combination thereof.

11. The composition according to claim 1, comprising:
a) from about 0.8% to about 3%, by weight of the composition, of said soil dispersant, wherein said soil dispersant is a polyethyleneimine ethoxylate having a PEI as a backbone and one or more side chains of formula (I) bonded to a nitrogen atom of the PEI backbone,
-(EO)_{b}(PO)_{c} (I)
wherein the polyethyleneimine ethoxylate has a PEI backbone of MWₙ ranging from about 300 to about 3,000; b ranges from 15 to 35; and c is 0;
b) from about 0.11% to about 0.25%, by weight of the composition, of said microcapsule, wherein said coating comprises an efficiency polymer that is a polyvinyl formamide; and
c) from about 0.05% to about 1%, by weight of the composition, of a hydrogenated castor oil.

12. The use of the liquid cleaning composition according to of claims 1 for pretreating a fabric.

13. The use of a liquid cleaning composition for pretreating a fabric, wherein the composition comprises:
a) a soil dispersant comprising an alkylene amine backbone and a side chain bonded to the nitrogen atom of the alkylene amine backbone, wherein the side chain is of formula (I),
-(EO)_{b}(PO)_{c} (I)
wherein b ranges from 3 to 60, and c ranges from 0 to 60; and
b) a microcapsule, wherein said microcapsule comprises: a shell comprising an outer surface, a core encapsulated within said shell, and a coating coating said outer surface, wherein said coating is cationically charged.
